(19) United States
(12) Patent Application Publication
(10) Pub. No.: US 2021/0401554 A1
(43) Pub. Date: Dec. 30, 2021

(54) SEAMLESS CIRCULAR DENTAL FLOSS

(71) Applicant: Jiping Shih, Gardnerville, NV (US)

(72) Inventor: Jiping Shih, Gardnerville, NV (US)

(21) Appl. No.: 16/911,386

(22) Filed: Jun. 24, 2020

(51) Int. Cl. A61C 15/04

(52) U.S. Cl. CPC A61C 15/041; A61C 15/043

(57) ABSTRACT

The present invention is related to a seamless and smooth circular dental floss for cleaning the gap between teeth with the advantages of great simplicity and cost effectiveness. A convenient dental floss package containing three sets of seamless and smooth circular floss with three different but preferred diameters, such as 50 mm, 70 mm and 90 mm may be provided for benefiting a family use or different habits in size.

### FIELD OF THE DISCLOSURE

In general, the invention relates to a dental floss which is produced in a fora of seamless circular string for general hygienic dental teeth flossing. Each dental floss is a smooth single circle without any knots.

### BACKGROUND OF THE DISCLOSURE

When practicing a dental flossing to remove debris trapped between teeth or clean the gaps between teeth, there are basically two types of practical methods.

The first type is a combined dental floss string and a device that holds two ends of a dental floss string. Representative prior arts include U.S. Pat. No. 10,517,703, 10,206,765, 9,844,432. The common disadvantage of this type of dental flossing is that adding such a device will significantly increase the cost of dental floss products.

The second type is without the aid of a device when flossing, for example a certain length of string of dental floss with one end being tied on a finger on the left hand and the other end being tied on a finger on the right hand, however, it still needs a dispenser to store and cut the dental floss. The common disadvantage of this type of dental flossing is that both fingers suffer discomfort due to being tightly tied by several turns of the thin dental floss string.

Furthermore, there are two different forms of dental floss, one is a smooth string or strip which is the most popular as seen in our daily life, and another is a string with at least one knot. Obviously, adding knots to the dental floss will increase the manufacturing cost. Representative prior arts include United Patent Application Publication #2015/0122281, United Patent Application Publication #2019/0117353 and United Patent Application Publication #2019/0076224.

### SUMMARY OF THE INVENTION

The embodiments as presented in this invention is related to an improved dental floss for hygienic cleaning with great simplicity and cost effectiveness. The dental floss disclosed in this invention is in a unique form of seamless circular string and smooth without any knots along its circumference.

A seamless circular dental floss is basically no waste of dental floss as contrast that a strip of non-circular dental floss has unusable portions at the two ends. In addition, a seamless circular dental floss does not need a dispenser to store and cut a dental floss strip, thus economically benefiting both the users and the manufacturers.

A further advantage of the present invention is to provide a dental floss package containing multiple sets of seamless and smooth circular floss with different diameters being convenient for a family use or for alternative habits in size.

The seamless circular dental floss may be produced by a number of methods including but not limiting to pressured heating, fusion heating, bonding using medical grade non-hardening adhesive containing PTFE, being mechanically sewed together, or be g mechanically pressured/sewed together. Practices and experiences demonstrate that a method of manually tying two ends of a dental floss strip to make a circular dental floss does not work well simply because almost all kinds of dental floss are very slippery or slick. The floss materials for the seamless circular dental floss as presented in this invention include but not limit to nylon, polymer, silk, Teflon and synthetic compounds.

### BRIEF DESCRIPTION OF THE DRAWINGS

FIG. 1 shows three sets of seamless and smooth circular floss with different diameters.

FIG. 2 is a brief perspective view demonstrating the method of using the seamless and smooth circular dental floss in the present invention.

### DETAILED DESCRIPTION OF THE INVENTION

The present invention is related to a seamless and smooth circular dental floss for hygienic dental teeth cleaning with the advantages of great simplicity and cost effectiveness. The smooth here means the dental floss is a continuously smooth circle without any knots along its circumference.

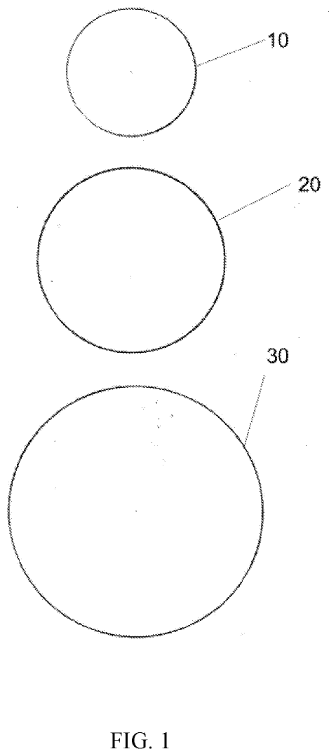

FIG. 1 shows a seamless circular dental floss 10 with a small diameter, a seamless circular dental floss 20 with a medium diameter, and a seamless circular dental floss 30 with a large diameter. Each of the seamless circular floss 10, 20 or 30 is in a form of a seamless circle and smooth string without any knots. The diameter of the floss 10 may range from 40 mm to 60 mm and ideally 50 mm. The diameter of the floss 20 may range from 60 mm to 80 mm and ideally 70 mm. The diameter of the floss 30 may range from 80 mm to 100 mm and ideally 90 mm.

The unique form of seamless circular floss 10, 20 or 30 shown in FIG. 1 enables to maximally utilize the full circumference of the floss without the waste as compared with using a strip floss due to the obvious unusable portions at two ends. Also the seamless circular floss 10, 20 or 30 in this invention may reduce the discomfort at fingers as compared with a strip of non-circular floss due to the tension caused by the tightly tied floss strips.

Furthermore, the seamless circular dental floss 10, 20 Or 30 does not need a dispenser to store and cut a dental floss strip, thus no need for making expensive tooling and molds to produce the dispensing device. In addition, the feature of smoothness with no knots along the circumference of the seamless circular floss 10, 20 or 30 further reduces the manufacturing cost.

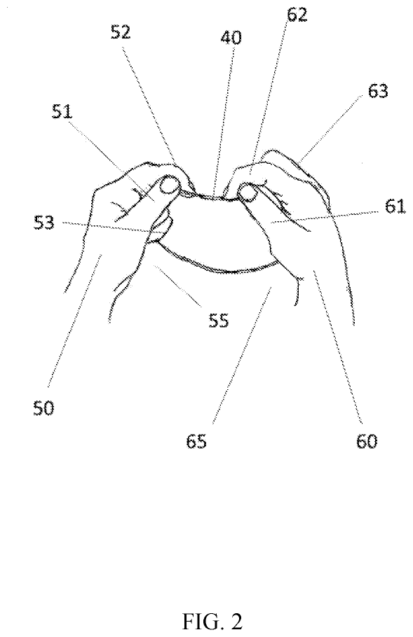

FIG. 2 demonstrates the method of using the seamless and smooth circular dental floss 40 as the present invention. Since the floss 40 is a complete circle, a user may use thumb 51 and index finger 52 on the left hand 50 to hold one spot of the floss 40 and use thumb 61 and index finger 62 on the right hand 60 to hold another spot of the floss 40, and then comfortably let the remaining floss 40 go through between the rest fingers 53 (partially shown) and the palm 55 (invisible) on the left hand 50, as well as through between the rest fingers 63 (partially shown) and the palm 65 (invisible) on the right hand 60. If there is a need to apply a force on the dental floss 40 during the flossing process, the tension will be acting on almost all the fingers together, thus the resulted stress will be significantly reduced.

Since there is no need for any device for the seamless and smooth circular dental floss as presented in this invention, such a great simplicity may conveniently provide a dental floss package containing three sets of seamless and smooth circular floss with three different but preferred diameters, such as 50 mm, 70 mm and 90 mm being convenient for a family use or for different habits in size.

There may be a number of choices for floss materials for the seamless circular dental floss as presented in this invention such as nylon, polymer, Teflon, any suitable synthetic compounds, etc. Once a floss material is determined, the seamless circular dental floss may be produced by a number of methods including but not limiting to pressured heating, fusion heating, bonding using medical grade non-hardening adhesive containing PTFE, being mechanically sewed together, or being mechanically pressured/sewed together.

Each of the patents and other documents identified herein are hereby incorporated in their entirety by reference herein only to the extent that the incorporated material does not conflict with existing definitions, statements, or other disclosure material set forth in this disclosure. As such, and to the extent necessary, the disclosure as set forth herein supersedes any conflicting material incorporated herein by reference. Any material, or portion thereof, that is said to be incorporated by reference herein, but which conflicts with existing definitions, statements, or other disclosure material set forth herein is only incorporated to the extent that no conflict arises between that incorporated material and the existing disclosure material.

Other embodiments of the present invention will be apparent to those skilled in the art from a consideration of the specification or a practice of the invention disclosed herein. It is intended that the specification and examples are illustrative only and are not intended to be limiting on the scope of the invention. The true scope and spirit of the present invention is indicated by the following claims.

What is claimed is:

1. A hygienic dental floss for removing debris trapped between teeth comprising a seamless circular dental floss.

2. The hygienic dental flossing of claim 1, wherein the seamless circular dental floss is a continuously smooth circle.

3. The hygienic dental flossing of claim 2, wherein the continuously smooth circle does not comprise any knots along its circumference.

4. The hygienic dental floss of claim 1, wherein the seamless circular dental floss does not need a dispenser device to store and dispense the floss.

5. A hygienic dental floss comprising the seamless and smooth circular dental floss:
wherein the feature of said seamless of the circular dental floss is achieved by a method of bonding under heat and pressure;
wherein the feature of said seamless of the circular dental floss is alternatively achieved by a method of bonding using a medical grade non-hardening adhesive containing PTFE;
wherein the feature of said seamless of the circular dental floss is alternatively achieved by a method of mechanical sewing;
wherein the feature of said seamless of the circular dental floss is alternatively achieved by a method of being mechanically pressured/sewed together;
and
wherein the feature of said smooth of the circular dental floss is characterized by no knots along the floss circumference.

6. A hygienic dental floss package comprising three sets of the seamless and smooth circular dental floss:
wherein the first set of seamless and smooth circular dental floss comprising a circular floss diameter ranging from 40 mm to 60 mm;
wherein the second set of seamless and smooth circular dental floss comprising a circular floss diameter ranging from 60 mm to 80 mm; and
wherein the third set of seamless and smooth circular dental floss comprising a circular floss diameter ranging from 80 mm to 100 mm.

7. The hygienic dental floss package comprising three sets of the seamless and smooth circular dental floss in claim 6 wherein the first set of seamless and smooth circular dental floss has a diameter of 50 mm.

8. The hygienic dental floss package comprising three sets of the seamless and smooth circular dental floss in claim 6 wherein the second set of seamless and smooth circular dental floss has a diameter of 70 mm.

9. The hygienic dental floss package comprising three sets of the seamless and smooth circular dental floss in claim 6 wherein the third set of seamless and smooth circular dental floss has a diameter of 90 mm.

10. The hygienic dental floss package comprising three sets of the seamless and smooth circular dental floss in claim 6 wherein each set of the seamless and smooth circular dental floss does not need any device to store and use the floss, thus providing great simplicity and cost effectiveness.
